(19) United States
(12) Patent Application Publication
(10) Pub. No.: US 2022/0335049 A1
(43) Pub. Date: Oct. 20, 2022

(54) Powering Scalable Data Warehousing with Robust Query Performance

(71) Applicant: Google LLC, Mountain View, CA (US)

(72) Inventors: Vahit Hakan Hacigumus, San Jose, CA (US); Ankur Agiwal, Santa Clara, CA (US); Kevin I. Lai, East Palo Alto, CA (US); Gokulnath Babu Manoharan, Santa Clara, CA (US); Indrajit Roy, Menlo Park, CA (US); Jagan Sankaranarayanan, San Jose, CA (US); Hao Zhang, Shanghai (CN); Tao Zou, Sunnyvale, CA (US); Rajesh Sambavarvadakarai Rajagopalan, Sunnyvale, CA (US)

(21) Appl. No.: 17/720,862

(22) Filed: Apr. 14, 2022

Related U.S. Application Data
(60) Provisional application No. 63/174,692, filed on Apr. 14, 2021.

(51) Int. Cl. G06F 16/2457; G06F 16/2455; G06F 16/23; G06F 16/22; G06F 9/46

(52) U.S. Cl. CPC G06F 16/24573; G06F 16/24554; G06F 16/2322; G06F 16/2282; G06F 9/466

(57) ABSTRACT

The present disclosure describes an analytical data management system (ADMS) that serves critical dashboards, applications, and internal users. This ADMS has high scalability, and availability through replication and failover, high user query load, and large data volumes. The ADMS provides continuous ingestion and high performance querying with tunable freshness. It further advances the idea of disaggregation by decoupling its architectural components: ingestion, indexing, and querying. As a result, the impact of a slow down in indexing on the query performance is minimized by either trading off data freshness or incurring higher costs.

### CROSS-REFERENCE TO RELATED APPLICATIONS

The present application claims the benefit of the filing date of U.S. Provisional Patent Application No. 63/174,692 filed Apr. 14, 2021, the disclosure of which is hereby incorporated herein by reference.

### BACKGROUND

Service providers for Internet services may rely on application data to provide better user experiences, to improve quality of service, and for billing. Business users interact with this data through sophisticated analytical front-ends to gain insights into their businesses. These front-ends issue complex analytical queries over vast amounts of data and impose severe time constraints, in some cases, service level objectives on the order of milliseconds. There are multiple petabytes of this data and it is continuously updated by a massive planetary-scale stream of updates. Users require the query results to be consistent and fresh, and demand continuous availability in the face of data center failures or network partitions.

There are numerous commercial offerings for analytical data management. Technology advances on these commercial systems include columnar storage, query optimization, as well as multiple designs for write- and update-optimized indexing. Traditional data analytics systems have evolved from tight coupling of storage and compute to the disaggregated model of decoupled storage and compute to take advantage of the cloud computing paradigm.

### BRIEF SUMMARY

The present disclosure describes an analytical data management system (ADMS) that serves critical dashboards, applications, and internal users. This ADMS has high scalability, and availability through replication and failover, high user query load, and large data volumes. The ADMS provides continuous ingestion and high performance querying with tunable freshness. It further advances the idea of disaggregation by decoupling its architectural components: ingestion, indexing, and querying. As a result, the impact of a slow down in indexing on the query performance is minimized by either trading off data freshness or incurring higher costs.

Whereas current data management storage systems typically rely on scans sped up by columnar storage, parallelism, and compression, the ADMS described herein relies on views to guarantee robust query performance Views are optimized for continuous high-bandwidth insertions using Log Structured Merge (LSM) forests. The ADMS provides clients with flexible configurable parameters for query performance, freshness, and costs. A Queryable Timestamp (QT) provides a live marker or indicator of the client's database production performance against the said requirements. Because of the configurability of the ADMS, the same system under different configurations can serve cost-conscious clients as well as demands around high performance and freshness.

According to examples described herein, the ADMS is a fully indexed system that is optimized for key lookups, range scans, and efficient incremental maintenance of indexes on tables and views. It can easily support both ad hoc queries and highly selective and less diverse queries. It is a multi-tenant, multihomed, distributed, globally-replicated data management system, which may be used by mission-critical applications. It provides a single database-level queryable timestamp, which means that a user can reference and query multiple tables and views in a consistent manner. It also supports views with full SQL generality; a subset of them can be continuously maintained.

B-trees are the principal index structures in many traditional database management systems. According to examples described herein, the ADMS uses a variant of B+-trees that exploits the fact that the ADMS tables have multi-part keys. Additionally, min/max keys, per-column min/max values are stored along with each non-leaf block to enable effective pruning. Log Structured Merge trees (LSM) adapt B-tree indexes for high update rates. The ADMS belongs to a class of LSM systems that trade high write throughput for fast reads. Writes are written to level files which get compacted to form larger level files. Reads merge these at run-time. The efficiency of the LSM data structure is measured by “write amplification” or the number of times an input row is written to disk (across all levels).

One aspect of the disclosure provides an analytical data management system (ADMS), comprising: an ingestion framework configured to commit updates into one or more tables of data stored in memory, a storage framework configured to compact the one or more tables and incrementally apply the updates to the one or more tables, and a query serving framework configured to respond to client queries. Compacting the one or more tables may comprise merging a plurality of incremental updates prior to applying the updates to the one or more tables.

The query serving framework may direct queries to precomputed materialized views. The one or more tables, including the precomputed materialized views, may be sorted, indexed, and range partitioned by primary keys.

According to some examples, a data plane comprises the ingestion framework, storage framework, and query serving framework, and a control plane comprises a controller, wherein the controller coordinates work among the ingestion framework, storage framework, and query serving framework.

According to some examples, the controller schedules compaction and view update tasks. The controller may coordinate metadata transactions across multiple data centers.

The ingestion framework may be configured to ingest multiple rows of data, each row being assigned a metadata timestamp. The ingesting of the multiple rows of data may include batching, aggregating, and replicating the data. The ingestion framework may include a plurality of replicas at different geographical locations, wherein the framework is configured to ingest the data at any of the plurality of replicas.

According to some examples, each table has a queryable timestamp indicating freshness of the data that can be queried. The freshness may be represented by a period of time equal to a current time minus the queryable timestamp. Any data ingested after the queryable timestamp may be hidden from client queries. The queryable timestamp may be updated when the data ingested is optimized to meet predefined query performance requirements. Parameters of freshness, performance, and cost may be reconfigurable.

Another aspect of the disclosure provides a method of managing an analytical data management system (ADMS), comprising committing, using an ingestion framework, updates into one or more tables of data stored in memory, compacting, with a storage framework, the one or more tables and incrementally apply the updates to the one or more tables, and responding, using a query serving framework, to client queries. According to some examples, the method may further include coordinating, with a controller in a control plane. work among a data plane comprising the ingestion framework, storage framework, and query serving framework. The method may further include scheduling, with the controller, compaction and view update tasks, and coordinating, with the controller, metadata transactions across multiple data centers. According to some examples, the method may further comprise ingesting, using the ingestion framework, multiple rows of data, each row being assigned a metadata timestamp. Each table may have a queryable timestamp indicating freshness of the data that can be queried, and any data ingested after the queryable timestamp is hidden from client queries. The method may further include optimizing ingested data to meet predefined query performance requirements, and updating the queryable timestamp when the data ingested is optimized.

### BRIEF DESCRIPTION OF THE DRAWINGS

FIG. 1 is a conceptual block diagram illustrating components of an analytical data management system (ADMS) according to aspects of the disclosure.

FIG. 2 is a block diagram illustrating an architecture of the ADMS according to aspects of the disclosure.

FIG. 3 is a schematic diagram illustrating ingestion of the ADMS according to aspects of the disclosure.

FIG. 4 is a timing diagram illustrating a queryable timestamp according to aspects of the disclosure.

FIGS. 5A-C illustrate different classes of views according to aspects of the disclosure.

FIG. 6 is a flow diagram illustrating a method of client query serving according to aspects of the disclosure.

FIGS. 7A-B are graphs illustrating latency measurements in connection with the ADMS according to aspects of the disclosure.

FIG. 8 is a block diagram showing an example system according to aspects of the disclosure.

FIG. 9 is a flow diagram illustrating an example method of ingestion according to aspects of the disclosure.

FIG. 10 is a flow diagram illustrating an example method of query serving according to aspects of the disclosure.

### DETAILED DESCRIPTION

The ADMS may serve many applications that differ in their requirements for the objectives of query performance, data freshness, and cost. Query performance and query latency are used interchangeably herein. Data freshness is measured by the time between when a row is added to a table to the time when it is available for querying. Freshness requirements range from a few minutes for freshness-sensitive clients to a couple of hours for cost-conscious clients. Costs may include, for example, machine resource costs that arise due to data processing. Examples of such costs include ingestion costs, background maintenance operations, and query execution. Typically, ingestion and maintenance costs dominate.

### Flexibility

Client needs can vary among the general categories of data freshness, resource costs, and query performance Some clients need high freshness, while others may want to optimize for raw query performance or low costs.

Ingestion and storage may be coupled. Ingestion refers to data being presented to the ADMS and beginning its merge into the system. Storage refers to the new data having been applied to the base table and all materialized views it affects. It may be undesirable to set constraints such that new data cannot be ingested until it has been fully processed, or that new data is coupled with querying such that it would slow down query performance. The ADMS provides clients the flexibility to tune the system and meet their goals around data freshness, resource costs, and query performance.

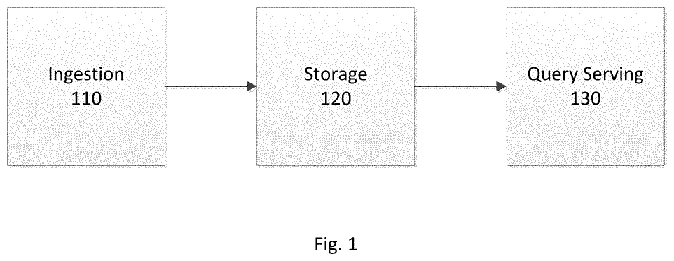

FIG. 1 is a conceptual block diagram illustrating components of the ADMS. The ADMS is highly scalable to process a stream of updates while simultaneously serving millions of queries with good performance ADMS relies on materialized views for predictable and high query performance.

A high-level architecture of the ADMS consists of three main components as shown in FIG. 1: ingestion framework 110, storage framework 120, and query serving 130.

The ingestion framework 110 ingests rows of data at high rates, such as tens of GB/s of compressed data. It is responsible for committing updates, or “deltas,” into the tables. Such deltas may be, for example, one or more additional rows in a database table, a set of updates to one or more tables, or any of a variety of other types of updates. The deltas written by the ingestion framework 110 serve to satisfy the durability requirements of the ingestion framework 110, and are write optimized. These deltas may be further consolidated before they can be applied to tables and their associated views.

The storage framework 120 incrementally applies the updates to tables and their views. The ADMS tables and their views may be maintained incrementally as LSM forests, where each table is a collection of updates. Deltas may be constantly consolidated to form larger deltas during a compaction process. The view maintenance layer transforms table deltas into view deltas by applying the corresponding SQL transformation. The storage layer is also responsible for periodically compacting tables and views. It maintains materialized views that are indexed and consistent across datacenters.

The query serving framework 130 is responsible for answering client queries. The system performs merging of necessary deltas of the table (or view) at query time. Query latency is a function of the query time merge effort so the faster the storage subsystem can process updates, the fewer deltas that need to be merged at query time.

The ADMS decouples ingestion from view maintenance, and view maintenance from query processing. This decoupling provides ADMS clients knobs to meet their requirements, allowing tradeoffs among freshness, performance, and cost. The ADMS requires the consistency of the base tables and the views, so decoupling ensures that the ADMS can keep making progress regardless of the performance of the individual components. The term “knob” may refer to an availability of a configurable option. Ingestion depends only on initial run generation, such as committing the updates, but not on merging or on view maintenance. ADMS also provides clients with high level choices that translate to selectively indexing data and limits the amount of merging at query time.

The ADMS clients can choose “low effort” to optimize for cost, accepting reduced query performance. “Low effort” means less aggressive compactions so that there is higher merging effort at query execution time. Low effort can also denote fewer materialized views, or reduced freshness, while still maintaining good query performance on queries that match the views. Similarly, clients can also choose to optimize for good query performance by paying for “higher effort,” such as more aggressive compactions, which results in low fan-in merges at query time, or can choose more targeted views.

Users may specify their requirements in terms of expected query performance, data freshness, and costs. These requirements are translated to internal database configurations such as the number of views, quota limits on processing tasks, the maximum number of deltas that can be opened during query processing, etc. These form a configuration of a client database at a point in time. However, the system is not static since data is constantly being ingested into the tables and one needs a dynamic yet easy to understand indicator of the database status in the context of the configuration generated from client requirements.

The ADMS introduces Queryable Timestamp (QT) to provide clients with a live marker. For example, QT may be an advancing timestamp, which is advanced when one or more conditions are met. Examples of such conditions may be that views for a table are consistent until a time T, that a number of deltas that need to be read for any query is less than X, that data is replicated to a quorum of datacenters, etc. QT is the direct indicator of freshness, and [Now( )−QT] indicates data delay. All data up to the QT timestamp can be queried by the client. Since QT can only be advanced when a required number of views have been generated and also upper-bounds the maximum number of deltas, it guarantees data used to serve query has met the conditions for delivering expected query performance. Furthermore, the continual advancement and staying within the freshness target of QT indicates the system is able to apply updates to the tables and views within the cost constraints specified in the database configuration.

In one example, the ADMS may have a cost-conscious client that runs an organization-wide internal experimental analysis framework. For this client, good query performance and moderate costs are important, even if the system needs lower data freshness. For this client, the QT advancement criteria is contingent on maintaining a moderate number of views and fewer deltas to merge at query execution time. To keep the cost low, the ADMS execution framework uses fewer worker tasks and cheaper opportunistic machine resources for view maintenance. As a result, even though view maintenance occurs at a slower pace, and hence data freshness is impacted, the ADMS provides this client good query performance at a moderate resource cost.

In a second example, the ADMS may have a client that requires fresh answers but has low or moderate query performance demands. For such clients, the QT advancement criteria is contingent on fewer views, but there can be relatively more deltas that need to be merged at query execution time. Since there are more deltas for each table and view, the query performance is lower. The query serving framework spends more time in I/O and collapses more rows which would otherwise happen offline during view maintenance and compaction. The ADMS execution framework directs more workers for ingestion, than view maintenance, since view maintenance effort is low. Therefore, these clients are able to trade query performance for better freshness and lower resource costs.

In a third example, the ADMS client powers a service provider's external dashboards. For this client, good query performance and data freshness are important, even at higher costs. For such clients, the ADMS QT advancement criteria is contingent on numerous views, sometimes hundreds for a single table, and that the number of deltas at merge time is very low to ensure shorter query execution time. The ADMS uses a large number of worker tasks to ensure this QT criteria can be met quickly by both faster ingestion and high throughput view maintenance. This QT advancement criteria provides the client the desired query performance and data freshness, however, at a relatively high resource cost.

Such different categories of client requirements are part of the system configuration and ADMS uses these configurations as a guidance to deliver the stipulated query performance, data freshness, and resource costs.

### Data Availability

Many services within a service provider may be architected to withstand data center scale outages that may result from catastrophic failures or scheduled maintenance. ADMS may provide a guarantee that the system remains operational in spite of such outages. This level of fault-tolerance may be provided by replicating client databases at multiple data centers and ensuring that the database replicas are mutually consistent. One approach would be to execute ADMS ingestion activity as synchronous transactions using a globally consistent transactional system. Another approach decouples the execution of data and metadata operations such that the data operations are executed asynchronously at each of the replicas at a data center, and metadata operations are used periodically to ensure that the replicas remain synchronized with each other. ADMS orchestrates the synchronous and asynchronous mode of this highly distributed machinery. The QT indicates a state at which all tables and views in a database are globally consistent across all data centers. Even though compaction and view maintenance are carried out asynchronously at each replica, the system moves from one consistent state to another.

### System Architecture

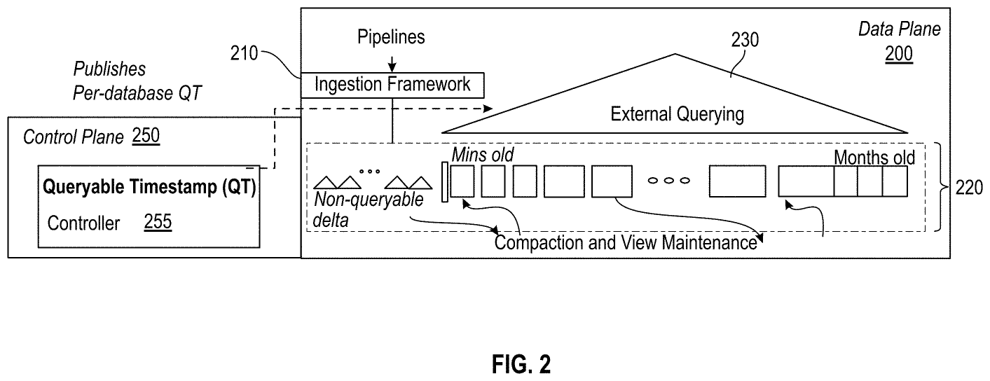

FIG. 2 illustrates an example of ADMS's high-level architecture, including data plane 200 and control plane 250. The architecture may be deployed at multiple data centers to manage the replicas at each data center. The data plane 250 includes ingestion 210, storage 220, and query serving 230. The control plane is made up of a controller 255 that coordinates work among the various subsystems. The controller 255 is also responsible for synchronizing and coordinating metadata transactions across multiple data centers. ADMS clients create databases and tables along with their associated schemas. The clients can optionally create materialized views for each table.

ADMS may be built by leveraging existing infrastructure components, such as a file system with disaggregated storage infrastructure. In this regard, a table in ADMS may be a collection of files in the disaggregated file system. ADMS may use a distributed database for functions that require strict transaction semantics, such as metadata management and storing system state. ADMS may use a query processing system, such as an SQL-compliant system, for query serving and large scale data processing, such as view creation and maintenance. The query processing system may support streaming and batch processing, and the same system can be used for interactive lookup queries as well as those that process large amounts of data. According to other examples, dedicated infrastructure for ADMS may be developed.

ADMS clients may use extract-transform-load (ETL) pipelines to insert data into their tables. The ingestion framework 210 can sustain very high load, such as tens of GB/s of compressed data. Client data is delivered to any of the ADMS replicas and ADMS ensures that the data ingestion is incorporated at all the data centers.

ADMS excels at serving workloads where clients issue aggregation queries with complex filters, e.g., those powering dashboards. As a result, the storage and view maintenance framework serves to maintain these aggregations. The storage framework 220 is responsible for compacting tables and incrementally updating views. Compaction requires merging deltas, typically with a high fan-in, to create larger deltas, which reduce merges during querying. This is similar to the post-processing in LSM trees, where I/O spent by an offline process shifts work away from online querying.

Query serving 230 deals with the necessary caching, prefetching and merging of deltas at run-time. Query serving aims to serve queries with low latency and low variance. Low latency is achieved by directing the queries to precomputed materialized views as opposed to the base table, and parallel execution of queries. Low variance is achieved by controlling the fan-in of the merges as well as a range of other I/O reduction and tail tolerance techniques.

ADMS relies on views for good query performance. ADMS tables including the materialized views are sorted, indexed, and range-partitioned by their (multi-part) primary keys. Strict latency and resource requirements of ADMS workloads favors leveraging indexed key lookups. Most ADMS queries can effectively be answered by range-partitioned indexed tables. ADMS may rely on merging and sorting performance for efficiency, and as such sorting, merging, and group-by operators may be sped up.

The ADMS controller 255 schedules compaction and view update tasks to keep the count of deltas for a table to a configurable value. These storage tasks may keep the Queryable Timestamp (QT) as fresh as possible given the cost tradeoffs. The database QT forms the basis of freshness of a database and is used by the query system to provide robust query performance as described earlier. ADMS supports database freshness of near-real time to a few hours; most clients require their databases to achieve approximately tens of minutes of freshness. If the freshness falls out of the desired range, the system continues to serve the client queries. However, the served data in that case would be stale as compared to the freshness requirements and administrative actions, such as adjusting the tradeoff by temporarily allowing higher cost, may be needed to bring the freshness back within the range. ADMS has hundreds of databases with hundreds to thousands of tables and views each with a steady ingestion rate. Yet, the system is able to maintain all these databases at the desired freshness, which is a testament to its robustness.

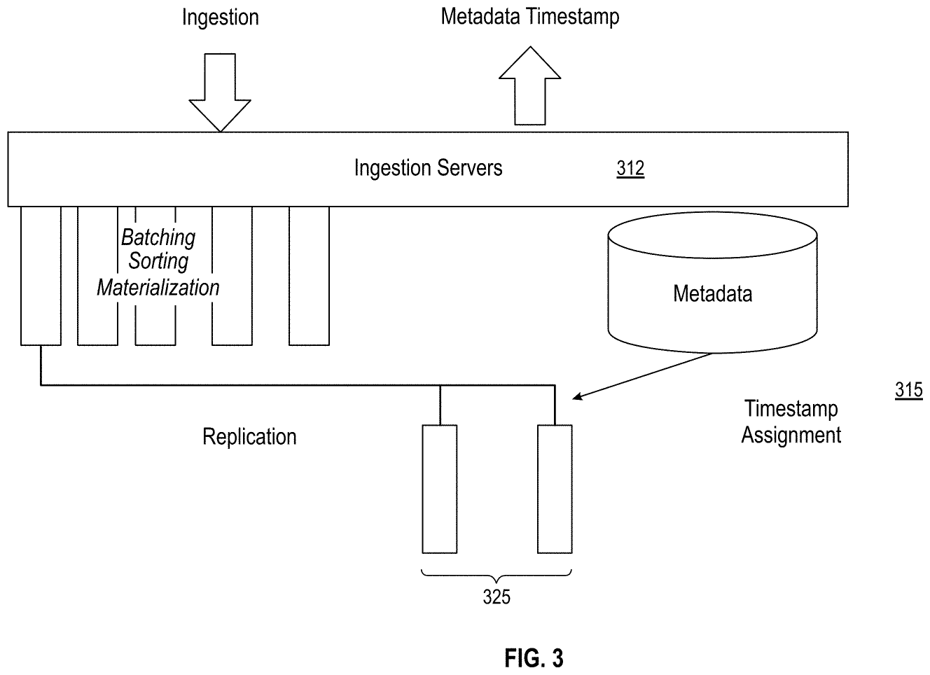

The ingestion framework 210 allows ingestion pipelines to insert large volumes of the data into ADMS without significant overhead. FIG. 3 is a schematic diagram illustrating ingestion of the ADMS. Ingestion servers 312 receive the data, and may perform batching, sorting, and materialization. All ingested rows are assigned a metadata timestamp 315 for ordering, and then marked as committed after other durability conditions, such as replication, have been satisfied. The ingestion framework provides knobs to limit the peak machine costs by allowing configurations to increase or decrease the numbers of tasks that accept data and perform the ingestion work of batching, aggregating, and replicating.

Clients deliver the data to be ingested to any one of the ADMS replicas 325. ADMS ensures that the data is ingested at all the replicas to ensure availability. The ingestion framework produces write-optimized deltas, in that they are small and their physical sizes are limited by the memory buffer of servers. These deltas are not immediately available for querying since there are many of these deltas, which will slow down query serving because it has to merge them. These deltas may be referred to as unqueryable and may need to be compacted before they can be queried.

### Queryable Timestamp

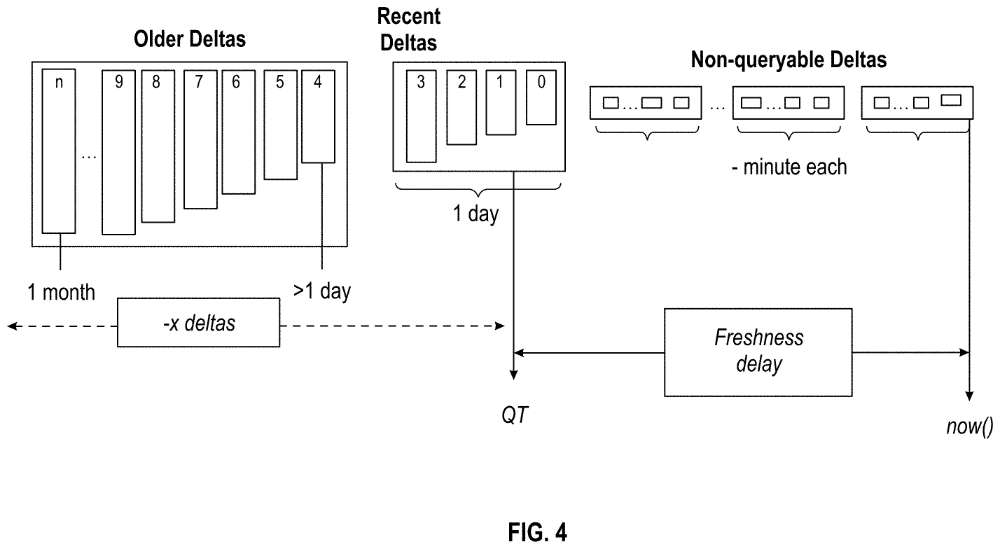

FIG. 4 is a timing diagram illustrating a queryable timestamp that decouples query performance from storage performance. The queryable timestamp (QT) of a table is a timestamp which indicates the freshness of data that can be queried. If QT(table)=X, all data that was ingested into the table before time X can be queried by the client and the data after time X is not part of the query results. In other words, the freshness of a table is [Now( )−QT]. QT acts as a barrier such that any data ingested after X is hidden from client queries. The value of QT will advance from X to Y once the data ingested in (Y−X) range has been optimized to meet the query performance requirements. In turn, clients can use ADMS's configuration options, and this single client visible metric to tune freshness, query performance, and costs. For example, if clients want high query performance and low costs, but can trade off freshness, the system prioritizes using fewer machine resources for view maintenance to reduce costs, and QT may progress slowly, thus indicating reduced data freshness.

Good query performance may be ensured by optimizing the underlying data for reads and ensuring views are available to speed up the queries. A table in ADMS is a collection of all of its delta files, each delta corresponding to updates received for the table over a window of time, as indicated in FIG. 4. The non-queryable deltas correspond to newly received updates written by the ingestion framework in the most recent time window (typically seconds). The largest deltas, on the other hand, span a time window of weeks or even months. Each delta is sorted by its keys, range partitioned, and has a local B-tree like index. These deltas are merged as needed at query time.

Most client queries have tight latency constraints and this places hard limits on the maximum number (x) of deltas that should be opened and merged during query execution. In particular, the queryable timestamp (QT) is the delta which forms x's boundary, counting from the oldest delta towards the newest. The limit may be, for example, a few tens of deltas. According to some examples, the limit may be automatically configured depending on query performance requirements on the database. For example, an automated module may dynamically adjust this limit based on the query workload. Tables with a high query workload and stringent query performance requirements have a lower limit, but those with lesser demanding query requirements have a higher limit. There are some practical limitations on how large a number x can be supported. As that number gets larger, queries start getting affected by tail effects. Given that query time merging is quite expensive, by keeping the number of deltas for a given database near constant, ADMS is able to provide robust query performance. In this regard ADMS provides a strong guarantee that the variance in query latency is low.

QT may be essentially dependent on the progress of background operations such as compactions and incremental view maintenance. The QT of the database is the minimum of the QT of all the tables in the database. QT is also used to give clients a consistent view of data across all ADMS replicas. Each replica has a local value of QT which is based on how fresh the data is in the local replica. The global value of QT is computed from the local QT values based on query serving availability requirements. For example, if 5 ADMS replicas have local QT values as 100, 90, 83, 75, 64 and query serving requires a majority of replicas to be available, then the new QT across all sites is set to 83 since the majority of the replicas are up to date at least up to 83. ADMS will use the replicas whose QT is at least 83 to answer queries, as it is guaranteed that queries to these replicas only need to read locally available deltas.

### Maintaining Views at Scale

ADMS's storage subsystem is responsible for maintaining views and compacting deltas. It is also responsible for ensuring data integrity, durability via replication across data centers, and handling outages from individual machines to entire data centers.

ADMS storage subsystem efficiently manages thousands of tables and views, such as at petabyte scale, even in the presence of data skew. The skew in view maintenance happens in the process of transforming the updates on the base tables into updates on the views. The mapping of the base table key space to the view key space may result in discontinuities where most of the base table updates may map to a narrow view key range resulting in skews. As the QT of the database is determined by the slowest view or table, the system has to adjust automatically to the variations in size and aforementioned data skews to ensure that the QT is not susceptible to the straggler views or tables. The storage subsystem also adjusts to the cost budget by varying the number of views, tasks, and the type of machine resources used. The view maintenance framework may include use of a query processing system as a “data pump,” replanning to avoid data skews, and intelligence in a loop.

With regard to use of a query processing system as a “data pump,” a relational data pump may be used to compact tables and maintain views. The view maintenance uses the query optimizer that can make good choices among alternative plans.

With regard to replanning to avoid data skews, the system can replan on the fly if it detects data skews. For example, the first key of many tables in ADMS is a date column which has a few distinct values. Even though the base table may have hundreds of key columns, most of the key columns are mostly zero or have strong correlation with another key. At large scale, the failure to detect skews may mean that the view maintenance query may never finish resulting in unbounded freshness delays.

With regard to intelligence in the loop, a database can advance QT only if all the tables and views have caught up. This means that the QT is blocked by the slowest views and requires a fairly sophisticated straggler mitigation. The ADMS controller implements the intelligence for tail mitigation, such as by using techniques of selecting data centers for task execution based on the historical load, active straggler task termination based on progress, and concurrent task execution to bound the size of the tails.

### Query Optimizations in View Maintenance

ADMS's view maintenance process effectively exploits data properties in the input. View update queries have to solve unique optimization challenges due to the amount of data processed and due to specific data properties, such as cardinality sparseness, correlations, etc. that complicate query processing at scale. Efficiently processing large amounts of data means that one has to be careful to not destroy beneficial data properties such as sortedness and partitioning, which are hard to recreate.

An example of a data property is the sort order of the view to be updated vis-a-vis the base table. One approach is to resort the view keys based on the view sort order regardless of the base table sort order. At mass scale, this would be an expensive processing proposition. Instead, it is beneficial to preserve input sortedness as much as possible; exploit sortedness even if the view's sort order and the base table sort order only partially overlaps. Similarly, changing the data partitioning property requires moving data across the network, which typically also clobbers sort, and should be avoided unless absolutely necessary.

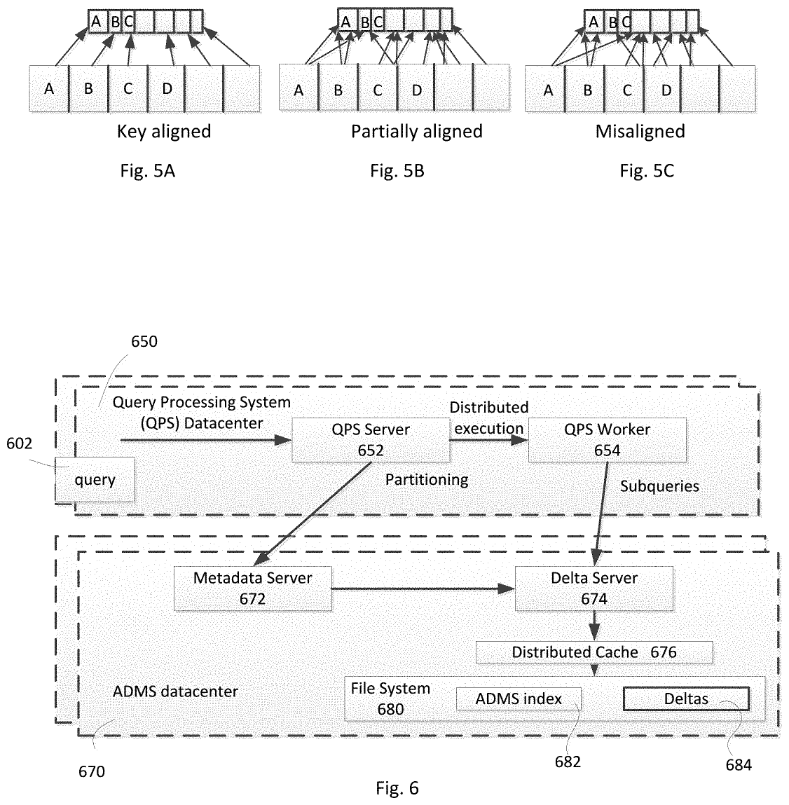

FIGS. 5A-C illustrate different classes of views, based on the commonality of the view and base table key columns. The first class of views are those that share a prefix with the base table, such as aligned views in FIG. 5A. For example, the base table has keys (A, B, C), while the view is on (A, B). In this case, the framework avoids sorting completely by clustering the input based on common key prefix (A, B) and aggregating in a streaming manner.

The second class of views are those that have a partial prefix with the base table but not a complete prefix, such as partially aligned views of FIG. 5B. For example, the base table has (A, B, C, D) while the view is on (A, B, D). The input sort order may be exploited by clustering the input base table on (A,B) and then sorting on D for each of the groups of unique (A, B). Clustering on a partial prefix can result in skews, which should be detected and remedied.

The third class of views are those where the base table and views do not share any prefix, such as the misaligned view of FIG. 5C. For example, the base table is (A, B, C, D) while the view is (D, C, A). There are few opportunities for optimization and these views are the most expensive in practice since they require both repartitioning and resorting.

Some views have a high aggregation reduction, such as 100-1000×, when compared with the base table and hence the view updates are tiny compared to the original table update. There are also views that are nearly the same size as the base table. For views with high cardinality reduction, preserving the sort order is not paramount since the output is small enough that it might be feasible to focus exclusively on reducing the cardinality and re-sort the output if needed. On the other hand, for cases where views have low aggregation, such as where the view is of similar size as the base table, sort and merge efficiency becomes important. A sort library for ADMS may be employed across all ADMS components that sort data—from the mutation servers to the sort operators.

### Compaction

Compaction combines multiple input deltas into a single output delta. Compaction improves query performance and reduces storage consumption by 1) sorting inputs together and 2) aggregating multiple updates to the same rows. Compacting asynchronously with respect to querying both reduces merging work at query time and leverages the compacted result across multiple queries. However, compactions are computationally expensive for high ingestion rate tables and they reduce data freshness by delaying when data becomes queryable. As mentioned earlier, the client's configuration controls this tradeoff. For example, a configuration that optimizes for query performance will compact frequently such that the maximum number of deltas merged at query time is less than 10, but such a configuration has significant ingestion delay and high compaction costs.

Since the delta files are individually sorted, compaction may be similar to merge sorting. Unlike client queries where the fan-in of the merge is kept small and bounded to avoid tail effects, it is intentionally kept large during compaction so that the height of the merge tree is small, thus minimizing key comparisons. A compaction query may have a fan-in of up to approximately a thousand inputs, beyond which the merge performance may deteriorate. The merge process divides a fixed memory budget among the various inputs. At approximately a thousand inputs, the memory per input stream is small. To add to that, the merge process stops when one of the inputs is consumed. At a thousand merge-way this happens 100× more frequently than it would happen at 10-way merge. The combination of these two effects make large merge-ways non-performant, which is remedied by I/O prefetching.

### Robust Query Serving Performance

FIG. 6 is a flow diagram illustrating mechanics of client query serving in ADMS. Many ADMS clients may have business use cases that require obtaining query results within the order of milliseconds. The latency requirement applies to tail cases, e.g. 99th percentile, for range lookups to petabyte sized tables, and when the underlying shared infrastructure fluctuates in performance and availability. The query serving subsystem may achieve robust performance using Queryable Timestamp (QT), materialized views, and a range of other techniques.

As shown in FIG. 6, a query 602 is received at query processing system (QPS) datacenter 650. QPS server 652 partitions them into a plurality of subqueries. For example, the QPS server 652 may partition the query 602 into tens, hundreds, thousands, tens of thousands, or more subqueries. The partitioning may be based on, for example, filter predicates, latency budget, and/or availability of query serving resources to improve performance Distributed execution of the partitioned query may be performed by one or more QPS workers 654. For example, the QPS workers 654 may read data from delta server 674. Metadata server 672 may process metadata. According to some examples, the version of metadata to be processed is based on the QT. The metadata server 672 may also determine, based on the metadata, which data has to be processed. Delta server 674 may read deltas 684 through a distributed cache 676. The deltas 684 may be stored in a file system 680 in ADMS datacenter 670, along with ADMS index 682.

ADMS uses multiple techniques to reduce the amount of data read to answer queries on the critical path. Whenever possible, ADMS uses views to answer a query instead of the base table, since views with aggregation functions may have significantly less data. When QPS workers 654 read data from delta servers 674, filters and partial aggregations are pushed down to minimize the amount of bytes transferred to QPS workers 654 via the network. QPS workers 654 and ADMS storage, such as file system 680, are not always collocated in the same data center. Cross data center network transfers may have larger variance in delay than intra-data center transfers. ADMS also relies on parallelism to reduce the amount of data each subquery has to read. ADMS maintains sparse B-tree indexes on its stored data, and uses them to quickly partition an input query into thousands of subqueries that satisfy the filter predicates. This partitioning mechanism additionally looks at the latency budget and availability of query serving resources to achieve good performance.

Given mass scale datasets, and reliance on shared and disaggregated storage, high latency may occur if metadata or data has to be read from disk or even SSDs. Examples of such metadata may include data statistics, view definitions, delta metadata, etc. When a query 602 is issued, ADMS uses the value of QT to decide the version of metadata to be processed. The metadata in turns determines what data has to be processed. Therefore, metadata reads may be on the critical path of query serving. ADMS ensures all metadata can always be served from memory without contacting the persistent storage. This is achieved by a metadata cache, such as affinity-based distributed metadata caching, with periodic background refreshes. A particular QT is delayed to wait for the completion of periodic background refresh of metadata.

All data reads go through a transparent distributed data caching layer 676 through which file I/O operations pass. The distributed cache 676 is read-through and shares work on concurrent read misses of the same data. Sharing work improves the efficiency of the distributed cache. Multiple delta servers 674 may read an overlapping range of index files when processing different subqueries of the same query, and the distributed data caching 676 makes sure such reads are processed only once.

The distributed caching layer 676 significantly reduces the number of I/Os. ADMS may perform offline and online prefetching to further reduce the number of sequential I/Os in the critical path. Offline prefetching may occur as soon as data is ingested for frequently queried tables, before QT advances to make the new data available to query. Online prefetching starts when a query 602 arrives and may be performed by a shadow query executor which shares the data access pattern with the main query executor but skips all query processing steps. Since the shadow query executor skips processing, it runs ahead of the main query executor, achieving the effect of more accurate prefetching than disk readahead based on past accesses.

During query serving, ADMS aggressively parallelizes the work by partitioning the query into fine grained units and then parallelizing I/O calls across deltas and across queried columns. Such parallelization may incur tail latency. For example, if each ADMS query issues 1000 parallel I/Os to disk, ADMS's 90th percentile latency would be affected by the underlying disk storage's 99.99^{th} percentile latency, which is often much higher than its 90th, 99th, and 99.9th percentile latency. To combat such amplification on tail latency, ADMS uses QT to limit the number of queryable deltas. In addition, ADMS may combine small I/Os as much as possible, such as by using techniques of lazy merging across deltas and size-based disk layout.

With respect to lazy merging across deltas, in a straightforward query plan, ADMS exposes itself as a data source with primary key to the query optimizer Each delta server 674, when processing a subquery, first merges rows across all deltas 684 based on the full primary key. When there are thousands (N) of subqueries and several tens (M) of deltas 684, the number of parallel IOs are in the order of tens of thousands (N×M). However, due to the parallelism each subquery reads very little data from most deltas 684. Meanwhile, a large fraction of ADMS queries require merging based on a subset of primary keys in the subsequent phase of the query plan. In these cases, ADMS adapts the query plan to avoid cross-delta merging in delta server 674 and lets each delta server 674 only process one delta, combining N×M parallel IOs into close to N parallel IOs.

With respect to size-based disk layout, ADMS uses a custom-built columnar storage format supporting multiple disk layout options, which are applied based on delta sizes. The PAX layout, which can combine all column accesses into one IO for lookup queries, may be applied to small deltas. For large deltas, column-by-column layout may be used that is IO efficient for scan queries but requires one IO per column for lookup queries. This size-based choice ensures that ADMS receives columnar storage benefits as well as reduces IO operations.

ADMS adopts the principle of tolerating tail latency. For a non-streaming remote procedure call (RPC), such as the RPC between metadata server 672 and delta server 674, ADMS uses the mechanism of hedging, which sends a secondary RPC identical to the original one to a different server after a certain delay, and waits for the faster reply.

For a streaming RPC, such as the RPC between query processing service (QPS) worker and Delta Server, ADMS estimates its expected progress rate and requires the server executing it periodically to report progress, together with a continuation token. If the reported progress is below expectation or the report is missing, the last continuation token would be used to restart a new streaming RPC on a different server without losing progress. Pushdown operators like filtering and partial aggregation need to be carefully handled in progress reporting as they can significantly reduce the data size, causing progress reports to be superficially low or even missing. ADMS uses bytes processed before filtering and partial aggregation as the progress rate metric and periodically forces these operators to flush its internal state to generate a progress report with a continuation token.

For datacenter-wide issues which impact query serving but not ingestion, the above tail tolerance mechanisms would kick in and automatically reroute the queries to servers in a neighboring data center. When ingestion is impacted, datacenter local QT is delayed in affected data centers and the query would be directly routed to other data centers based on the local QT values.

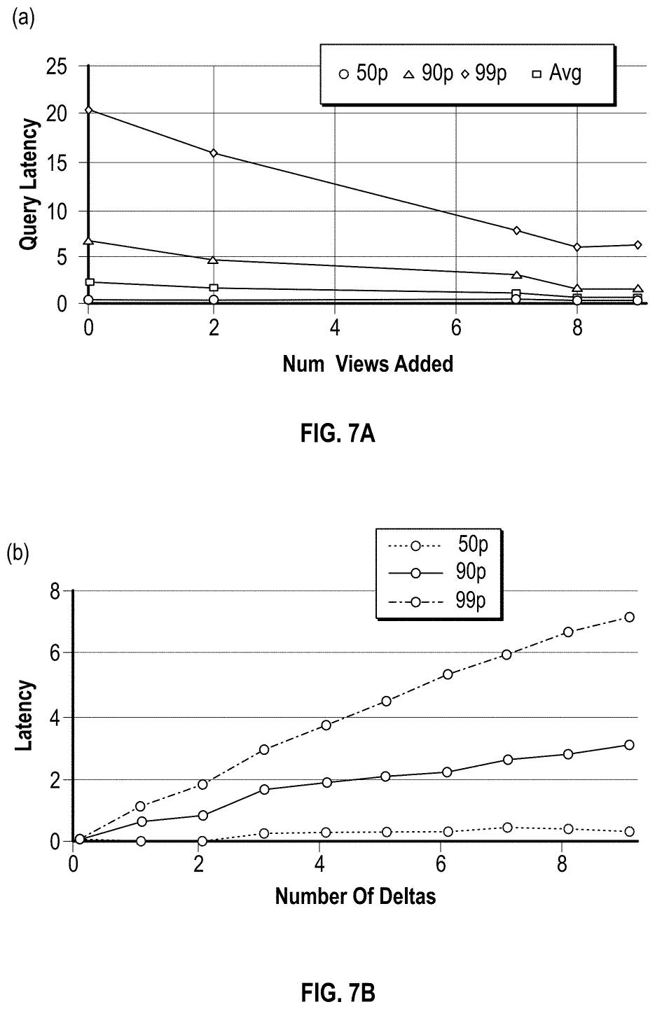

FIG. 7A shows query latency reduction with the increasing number of views, while FIG. 7B shows a number of deltas that a query is allowed to span and the corresponding latency impact. Lower latency impact is generally more beneficial.

ADMS is able to provide robust query performance by more actively using views, by changing storage policies and therefore reducing the number of deltas and hence the tail latency, and by decoupling ingesting, view maintenance, and query execution, thus mitigating the impact of infrastructure and workload changes on query performance.

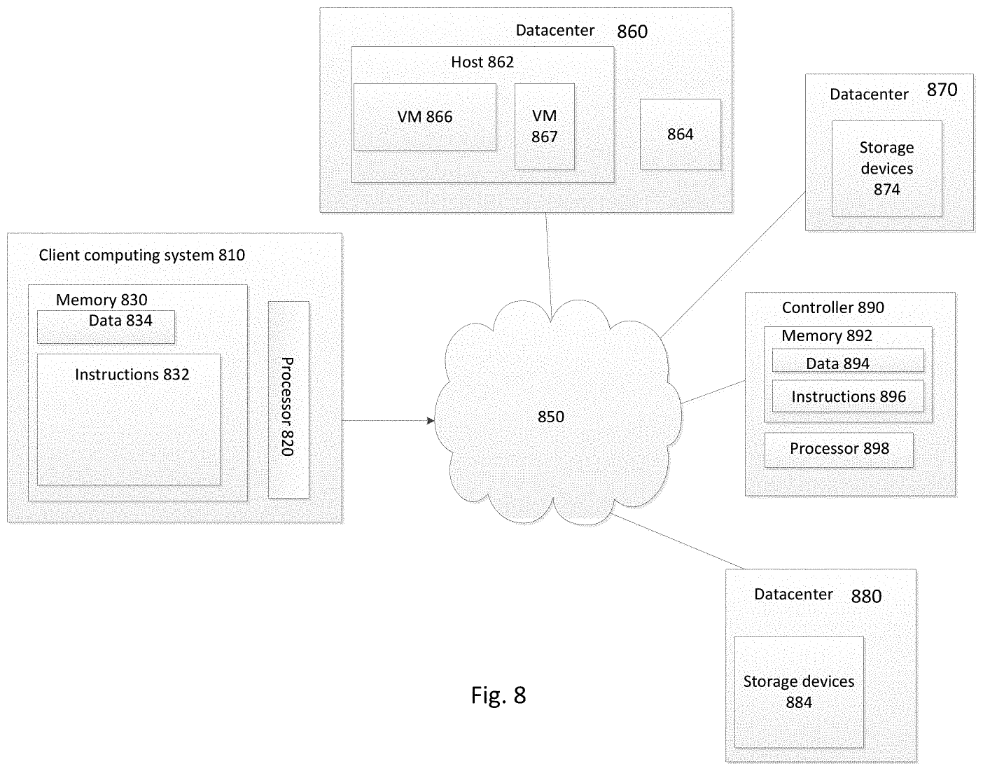

FIG. 8 illustrates an example distributed computing environment in which ADMS may be implemented. A plurality of datacenters 860, 870, 880 may be communicatively coupled, for example, over a network 850. The datacenters 860, 870, 880 may further communicate with one or more client devices, such as client 810, over the network 850. In some examples, the datacenters 860, 870, 880 may further communicate with a controller 890.

The datacenters 860-880 may be positioned a considerable distance from one another. For example, the datacenters may be positioned in various countries around the world. Each datacenter 860, 870, 880 may include one or more computing devices, such as processors, servers, shards, or the like. For example, as shown in FIG. 8, datacenter 860 includes host computing device 862 and a plurality of storage devices 864, datacenter 870 includes storage devices 874, and datacenter 880 includes storage devices 884. While processing devices, such as servers, hosts of virtual machines, or other processing devices, are not shown in datacenters 870, 880 it should be understood that they may also be included. According to some examples, the computing devices may include one or more virtual machines running on a host machine. Moreover, it should be understood that the configuration illustrated in FIG. 8 is merely an example, and that the computing devices in each of the example datacenters 860-880 may have various structures and components that may be the same or different from one another.

Programs may be executed across these computing devices, for example, such that some operations are executed by one or more computing devices of a first datacenter while other operations are performed by one or more computing devices of a second datacenter. In some examples, the computing devices in the various datacenters may have different capacities. For example, the different computing devices may have different processing speeds, workloads, etc. While only a few of these computing devices are shown, it should be understood that each datacenter 860, 870, 880 may include any number of computing devices, and that the number of computing devices in a first datacenter may differ from a number of computing devices in a second datacenter. Moreover, it should be understood that the number of computing devices in each datacenter 860-880 may vary over time, for example, as hardware is removed, replaced, upgraded, or expanded.

The storage devices 864, 874, 884 may include hard drives, random access memory, disks, disk arrays, tape drives, or any other types of storage devices. Storage 864, 874, 884 may be provided as a SAN within the datacenter hosting virtual machines supported by the storage or in a different data center that does not share a physical location with the virtual machines it supports. The datacenters 860-880 may implement any of a number of architectures and technologies, including, but not limited to, direct attached storage (DAS), network attached storage (NAS), storage area networks (SANs), fibre channel (FC), fibre channel over Ethernet (FCoE), mixed architecture networks, or the like. The datacenters 860-880 may include a number of other devices in addition to the storage devices, such as cabling, routers, etc. Further, in some examples the datacenters 860-880 may be virtualized environments. Further, while only a few datacenters 860-880 are shown, numerous datacenters may be coupled over the network 850 and/or additional networks.

The storage devices 864, 874, 884 may include data corresponding to a replicated disk. For example, a disk may be replicated in a first replica in a first storage device in datacenter 860, and also in a second replica in a second storage device in datacenter 880. According to other examples, the disk may be replicated across multiple different storage devices within the same datacenter. The number of storage devices across which the disk is replicated may be varied. For example, while in the present example the disk is replicated across two storage devices, according to other examples additional replicas may be implemented.

The virtual machine 866 may attach to one or more replicas of a disk. For example, the VM 866 may attach to a trusted replica.

In some examples, the controller 890 may communicate with the computing devices in the datacenters 860-880, and may facilitate the execution of programs. For example, the controller 890 may track the capacity, status, workload, or other information of each computing device, and use such information to assign tasks.

The controller 890 may contain a processor 898, memory 892, and other components typically present in general purpose computers. The memory 892 can store information accessible by the processor 898, including instructions 896 that can be executed by the processor 898. Memory can also include data 894 that can be retrieved, manipulated or stored by the processor 898. The memory 892 may be a type of non-transitory computer readable medium capable of storing information accessible by the processor 898, such as a hard-drive, solid state drive, tape drive, optical storage, memory card, ROM, RAM, DVD, CD-ROM, write-capable, and read-only memories. Systems may include different combinations of memory, whereby different portions of the instructions and data are stored on different types of media. The processor 898 can be a well-known processor or other lesser-known types of processors. Alternatively, the processor 898 can be a dedicated controller such as an ASIC.

The instructions 896 can be a set of instructions executed directly, such as machine code, or indirectly, such as scripts, by the processor 898. In this regard, the terms “instructions,” “steps” and “programs” can be used interchangeably herein. The instructions 896 can be stored in object code format for direct processing by the processor 898, or other types of computer language including scripts or collections of independent source code modules that are interpreted on demand or compiled in advance.

The data 894 can be retrieved, stored or modified by the processor 898 in accordance with the instructions 896. For instance, although the system and method is not limited by a particular data structure, the data 894 can be stored in computer registers, in a relational database as a table having a plurality of different fields and records, or XML documents. The data 894 can also be formatted in a computer-readable format such as, but not limited to, binary values, ASCII or Unicode. Moreover, the data 894 can include information sufficient to identify relevant information, such as numbers, descriptive text, proprietary codes, pointers, references to data stored in other memories, including other network locations, or information that is used by a function to calculate relevant data.

Although FIG. 8 functionally illustrates the processor 898 and memory 892 as being within the same block, the processor 898 and memory 892 may actually include multiple processors and memories that may or may not be stored within the same physical housing. For example, some of the instructions 896 and data 894 can be stored on a removable CD-ROM and others within a read-only computer chip. Some or all of the instructions and data can be stored in a location physically remote from, yet still accessible by, the processor 898. Similarly, the processor 898 can actually include a collection of processors, which may or may not operate in parallel.

The client 810 may include a processor 820 and memory 830, including data 834 and instructions 832, similar to the controller 890 described above. Each client 810 may be a personal computer, intended for use by a person having all the internal components normally found in a personal computer such as a central processing unit (CPU), CD-ROM, hard drive, and a display device, for example, a monitor having a screen, a projector, a touch-screen, a small LCD screen, a television, or another device such as an electrical device that can be operable to display information processed by processor 820, speakers, a modem and/or network interface device, user input, such as a mouse, keyboard, touch screen or microphone, and all of the components used for connecting these elements to one another. Moreover, computers in accordance with the systems and methods described herein may include devices capable of processing instructions and transmitting data to and from humans and other computers including general purpose computers, PDAs, tablets, mobile phones, smartwatches, network computers lacking local storage capability, set top boxes for televisions, and other networked devices.

Client 810 may include, for example, computing devices located at customer location that make use of cloud computing services such as Infrastructure as a Service (IaaS), Platform as a Service (PaaS), and/or Software as a Service (SaaS). For example, if a computing device 810 is located at a business enterprise, client 810 may use cloud systems as a service that provides software applications, e.g., accounting, word processing, inventory tracking, etc., applications, to client 810 used in operating enterprise systems. In addition, client 810 may access cloud computing systems as part of its operations that employ machine learning, deep learning, or more generally artificial intelligence technology, to train applications that supports its business enterprise.

Client 810, datacenters 860-880, and controller 890 can be capable of direct and indirect communication such as over network 850. For example, using an Internet socket, a client 810 can connect to a service operating on remote servers through an Internet protocol suite. Servers can set up listening sockets that may accept an initiating connection for sending and receiving information. The network 850, and intervening nodes, may include various configurations and protocols including the Internet, World Wide Web, intranets, virtual private networks, wide area networks, local networks, private networks using communication protocols proprietary to one or more companies, Ethernet, WiFi (e.g., 702.78, 702.78b, g, n, or other such standards), and HTTP, and various combinations of the foregoing. Such communication may be facilitated by a device capable of transmitting data to and from other computers, such as modems (e.g., dial-up, cable or fiber optic) and wireless interfaces.

In addition to the operations described above and illustrated in the figures, various operations will now be described. It should be understood that the following operations do not have to be performed in the precise order described below. Rather, various steps can be handled in a different order or simultaneously, and steps may also be added or omitted.

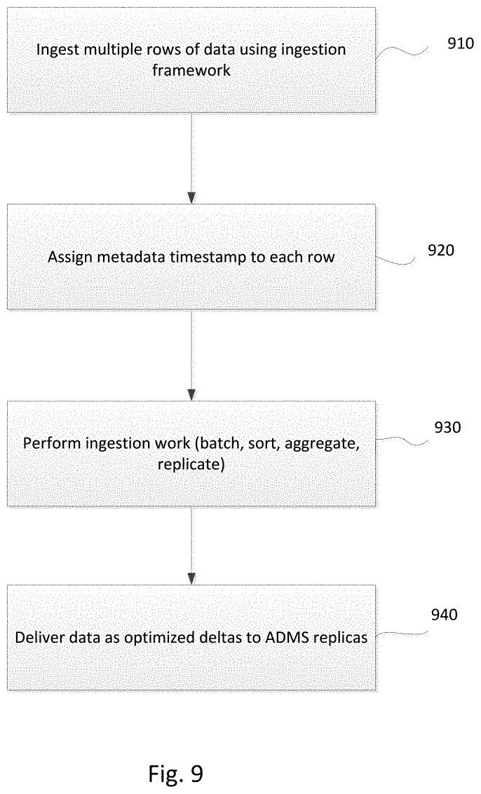

FIG. 9 illustrates an example method of ingesting data using ADMS. Such method may be performed, for example, using an ingestion framework.

In block 910, multiple rows of data are ingested using an ingestion framework, such as described above in connection with FIG. 3. For example, tens, thousands, hundreds of thousands, or more rows may be ingested.

In block 920, a metadata timestamp is assigned to each ingested row. In block 930, ingestion work is performed. For example, such ingestion work may include batching, sorting, aggregating, replicating, materialization, etc. According to some examples, the ingestion work may be performed using the assigned metadata timestamp. For example, the rows may be sorted based on the assigned metadata timestamp.

In block 940, the data from the ingested rows is delivered as optimized deltas to ADMS replicas. According to some examples, when each row may be marked as committed when replication is satisfied.

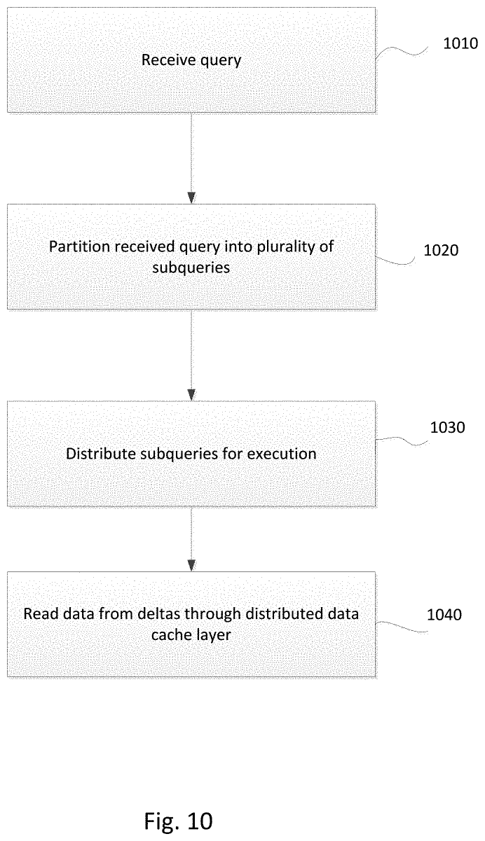

FIG. 10 illustrates an example method of querying using ADMS. Such method may be performed, for example, using a query serving framework, such as described above in connection with FIG. 6.

In block 1010, a query is received. In block 1020, the query may be partitioned into a plurality of subqueries. For example, the query may be partitioned into tens, thousands, or more subqueries. The partitioning may depend on available worker resources.

In block 1030, the subqueries are distributed for execution. For example, the subqueries may be distributed to a plurality of workers or servers in a distributed system.

In block 1040, data responsive to the query is read from deltas through a distributed data cache layer.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. An analytical data management system (ADMS), comprising:
an ingestion framework configured to commit updates into one or more tables of data stored in memory;
a storage framework configured to compact the one or more tables and incrementally apply the updates to the one or more tables; and
a query serving framework configured to respond to client queries.

2. The ADMS of claim 1, wherein compacting the one or more tables comprises merging a plurality of incremental updates prior to applying the updates to the one or more tables.

3. The ADMS of claim 1, wherein the query serving framework directs queries to precomputed materialized views.

4. The ADMS of claim 3, wherein the one or more tables, including the precomputed materialized views, are sorted, indexed, and range partitioned by primary keys.

5. The ADMS of claim 1, further comprising:
a data plane comprising the ingestion framework, storage framework, and query serving framework; and
a control plane comprising a controller, wherein the controller coordinates work among the ingestion framework, storage framework, and query serving framework.

6. The ADMS of claim 5, wherein the controller schedules compaction and view update tasks.

7. The ADMS of claim 5, wherein the controller coordinates metadata transactions across multiple data centers.

8. The ADMS of claim 1, wherein the ingestion framework is configured to ingest multiple rows of data, each row being assigned a metadata timestamp.

9. The ADMS of claim 8, wherein ingesting the multiple rows of data further comprises batching, aggregating, and replicating the data.

10. The ADMS of claim 1, wherein the ingestion framework comprises a plurality of replicas at different geographical locations, and wherein the framework is configured to ingest the data at any of the plurality of replicas.

11. The ADMS of claim 1, wherein each table has a queryable timestamp indicating freshness of the data that can be queried.

12. The ADMS of claim 11, wherein the freshness is represented by a period of time equal to a current time minus the queryable timestamp.

13. The ADMS of claim 11, wherein any data ingested after the queryable timestamp is hidden from client queries.

14. The ADMS of claim 13, wherein the queryable timestamp is updated when the data ingested is optimized to meet predefined query performance requirements, wherein such optimization comprises at least one of limiting physical sizes of updates based on a memory buffer of servers or compaction.

15. The ADMS of claim 11, wherein parameters of freshness, performance, and cost are reconfigurable.

16. A method of managing an analytical data management system (ADMS), comprising:
committing, using an ingestion framework, updates into one or more tables of data stored in memory;
compacting, with a storage framework, the one or more tables and incrementally apply the updates to the one or more tables; and
responding, using a query serving framework, to client queries.

17. The method of claim 16, further comprising:
coordinating, with a controller in a control plane. work among a data plane comprising the ingestion framework, storage framework, and query serving framework.

18. The method of claim 17, further comprising:
scheduling, with the controller, compaction and view update tasks; and
coordinating, with the controller, metadata transactions across multiple data centers.

19. The method of claim 16, further comprising ingesting, using the ingestion framework, multiple rows of data, each row being assigned a metadata timestamp.

20. The method of claim 19, wherein each table has a queryable timestamp indicating freshness of the data that can be queried, and any data ingested after the queryable timestamp is hidden from client queries.

21. The method of claim 20, further comprising:
optimizing ingested data to meet predefined query performance requirements, wherein such optimization comprises at least one of limiting physical sizes of updates based on a memory buffer of servers or compaction; and
updating the queryable timestamp when the data ingested is optimized.
